(19) United States
(12) Patent Application Publication
(10) Pub. No.: US 2021/0260819 A1
(43) Pub. Date: Aug. 26, 2021

(54) SYSTEMS, APPARATUSES, AND METHODS FOR MANUFACTURING THREE DIMENSIONAL OBJECTS VIA CONTINUOUSLY CURING PHOTOPOLYMERS, UTILISING A VESSEL CONTAINING AN INTERFACE FLUID

(71) Applicant: CALT Dynamics Limited, Co. Wicklow (IE)

(72) Inventors: Ross LAWLESS, Newtownmountkennedy (IE); Irene VILLAFANE, Newtownmountkennedy (IE)

(21) Appl. No.: 17/174,574

(22) Filed: Feb. 12, 2021

Related U.S. Application Data
(60) Provisional application No. 62/979,758, filed on Feb. 21, 2020.

(51) Int. Cl. B29C 64/129; B29C 64/245; B29C 64/232; B29C 64/264; B29C 64/188; B29C 64/321; B33Y 10/00; B33Y 30/00; B33Y 40/20

(52) U.S. Cl. CPC B29C 64/129; B29C 64/245; B29C 64/232; B29C 64/264; B33Y 40/20; B29C 64/321; B33Y 10/00; B33Y 30/00; B29C 64/188

(57) ABSTRACT

A method and system for additively manufacturing an object is provided. The method including flowing an interface fluid into a vessel, the interface fluid having a first density. A photopolymer is flowed into the vessel, the photopolymer having a second density, the second density being less than the first density. A build plate is disposed within the photopolymer, the build plate being positioned a predetermined layer thickness from an interface of the photopolymer and interface fluid. At least a portion of the photopolymer is irradiated with a light source to define a first layer of an object being fabricated, the portion of the polymer being disposed between the interface fluid and the build plate. The build plate is moved in a direction away from the interface fluid a predetermined second distance.

This application may contain material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### TECHNICAL FIELD

Furthermore, the present disclosure relates to systems, apparatuses, and methods for additive manufacturing or printing of three dimensional (3D) objects, and more specifically, to additive manufacturing or 3D printing (3DP) having an interface fluid.

### BACKGROUND

Some types of manufacturing create physical objects by laying down or building up many thin layers of material in succession, this is sometimes referred to as “3D Printing.” A 3D printer can include a container for holding a liquid polymer that can be cured to produce a 3D object. The printer can include a light source and a controller that selectively controls the light source to expose the liquid polymer to light print the successive layers of the 3D object.

While existing 3D printers are suitable for their intended purposes the need for improvement remains, particularly in providing a 3D printing device having the features described herein.

### SUMMARY

According to one aspect of the disclosure a method is provided. The method including flowing an interface fluid into a vessel, the interface fluid having a first density. A photopolymer is flowed into the vessel, the photopolymer having a second density, the second density being less than the first density. A build plate is disposed within the photopolymer, the build plate being positioned a predetermined layer thickness from an interface of the photopolymer and interface fluid. At least a portion of the photopolymer is irradiated with a light source to define a first layer of an object being fabricated, the portion of the polymer being disposed between the interface fluid and the build plate. The build plate is moved in a direction away from the interface fluid a predetermined second distance.

In addition to one or more of the features described herein, or as an alternative, further embodiments of the method may include repeating the steps to define a second layer of the object being fabricated. In addition to one or more of the features described herein, or as an alternative, further embodiments of the method may include directing the flow of photopolymer upwards as the photopolymer enters the vessel and prior to contact with the interface fluid. In addition to one or more of the features described herein, or as an alternative, further embodiments of the method may include the interface fluid being saline.

In addition to one or more of the features described herein, or as an alternative, further embodiments of the method may include forming a meniscus with the interface fluid near the edge of the vessel, wherein the portion of the photopolymer is spaced apart from the meniscus. In addition to one or more of the features described herein, or as an alternative, further embodiments of the method may include flowing photopolymer into a space between the first layer and the interface fluid in response to moving the build plate. In addition to one or more of the features described herein, or as an alternative, further embodiments of the method may include continuously moving the build plate while the light source continuously and dynamically irradiates the photopolymer. In addition to one or more of the features described herein, or as an alternative, further embodiments of the method may include continuously separating the cured photopolymer from the interface fluid as the build plate is moved.

In accordance with another aspect of the disclosure, a system for forming an object through additive manufacturing is provided. The system including a vessel having a bottom side and an interface fluid disposed within the vessel. A photopolymer is disposed within the vessel and in contact with the interface fluid. A build plate is disposed within the photopolymer and spaced apart from the interface fluid, the build plate being movable from a first position to a second position. A light source is positioned to direct electromagnetic radiation into the build plate.

In addition to one or more of the features described herein, or as an alternative, further embodiments of the system may include the interface fluid being saline. In addition to one or more of the features described herein, or as an alternative, further embodiments of the system may include the vessel including at least one first structural feature configured to flow interface fluid into the vessel. In addition to one or more of the features described herein, or as an alternative, further embodiments of the system may include the vessel including at least one second structural feature configured to flow photopolymer into the vessel. In addition to one or more of the features described herein, or as an alternative, further embodiments of the system may include the second structural feature including a lip configured to direct photopolymer upwards as the photopolymer enters the interior of the vessel.

In addition to one or more of the features described herein, or as an alternative, further embodiments of the system may include one or more processors configured to continuously move the build plate as the light source continuously and dynamically irradiates the photopolymer in a predetermined pattern. In addition to one or more of the features described herein, or as an alternative, further embodiments of the system may include the vessel including an optically clear window between the interface fluid and the light source. In addition to one or more of the features described herein, or as an alternative, further embodiments of the system may include a linear drive mechanism operably coupled to the build plate, the linear drive mechanism being configured to move the build plate between the first position and the second position.

In addition to one or more of the features described herein, or as an alternative, further embodiments of the system may include a build arm coupled between the linear drive mechanism and the build plate. In addition to one or more of the features described herein, or as an alternative, further embodiments of the system may include a pump operably coupled to flow interface fluid into the vessel.

### BRIEF DESCRIPTION OF DRAWINGS

An understanding of the features of the disclosure herein may be had by reference to the appended drawings, which illustrate the method and system of the disclosure, although it will be understood that such drawings depict preferred embodiments of the disclosure and, therefore, are not to be considered as limiting its scope with regard to other embodiments which the disclosure is capable of contemplating. Furthermore, elements or components that are described with reference to any one figure may be interchanged with those of other figures without departing from the scope of the present teaching.

FIG. 1 is a schematic illustrations depicting an overview of a manufacturing device (e.g., a 3D printer or printing device) in accordance with an embodiment;

FIG. 2 is a schematic illustrations depicting the characteristics of an interface plane with reference to an example vessel 1, print bed, and other components of manufacturing devices in accordance with an embodiment;

FIG. 3 is a schematic illustrations of a system containing an interface material in accordance with an embodiment;

FIG. 4A and FIG. 4B are schematic illustrations depicts the SLIC printing process with time A showing an initial position of a print bed of a manufacturing device and then as the print progresses, time B showing where the components of the manufacturing device can be some time into the printing process, in accordance with an embodiment;

FIG. 5 is a partial front view of a 3D printing device with the SLIC—Vessel installed, in accordance with an embodiment;

FIG. 6 is a partial perspective view of the 3D printing device of FIG. 5 with the SLIC—Vessel installed, in accordance with an embodiment;

FIG. 7 is a flow diagram depicting an example operational flow of a manufacturing device, according to embodiments; and

FIG. 8 is a schematic illustration depicting a 3D printing system, according to an embodiment.

### DETAILED DESCRIPTION

Processes and devices described herein relate to additive manufacturing, also referred to as 3D printing. Such processes and devices can provide an alternative to standard release mechanisms of the additive process of forming objects by curing a photopolymer one layer after another against a vessel floor. In some embodiments, a process and apparatus for additive manufacturing uses an interface fluid placed against (e.g., in contact with) the photopolymer to allow for destruction free “separation” of cured polymer from the interface fluid in an oxygen free environment. The process incorporates the use of a vessel, which contains the interface fluid and photopolymer together. The process also comprises the use of a build plate and light source contained within a 3D printing device.

The descriptions herein refer to additive manufacturing processes and apparatus as well as to device(s) that utilize said processes and apparatus. Processes described herein can enable commercialization of low cost, fast additive manufacturing equipment. These processes can be different from currently available processes that use a different method of releasing a photopolymer, which usually occurs after curing any given layer. In embodiments described herein, a process referred to as the Solid-Liquid Interface Curing (SLIC) process, uses an interface liquid barrier between a light source and a photopolymer, e.g., to create a vacuum free cure zone. A lack of vacuum force/low pressure (or any other non-negligible force) between the solid cured photopolymer and liquid interface allows the build plate to move continuously (e.g., without turning off the light source and/or moving back-and-forth to separate cured polymer from the interface) during printing and it also achieves continuous non-destructive release, post curing of the photopolymer. With the SLIC process, the curing process does not require stopping to enable release of the photopolymer as when the photopolymer shrinks, rather than a low-pressure region being formed, the high density fluid maintains contact with the cured photopolymer.

Certain methods or processes for additive manufacturing of photopolymer materials may use a separation method (e.g., release mechanism) that requires stopping the curing process during the printing process. Processes and devices described herein do not require the build plate to stop or reverse direction, which can have significant time savings throughout the printing process. For example, such processes and devices do not require the build plate to lift, stop and then drop on each layer of photopolymer. Additionally, these processes do not require a light source to be disabled for a period of time to allow the release mechanism to complete, again having considerable time savings throughout the duration of the printing process.

Systems, apparatus, and methods are described for providing an additive manufacturing process involving continuously curing photopolymers using a vessel containing an interface fluid. In some embodiments, an apparatus includes a vessel designed to contain a photopolymer as well as an optically and UV transmissive fluid that is denser than the photopolymer. The use of the denser fluid can prevent printed part quality issues caused by printing at an open surface (e.g., an exposed surface) of the fluid photopolymer and/or increase print speed by eliminating a separation step that is common in the operation of some 3D printers. Due to the viscosity and surface tension present in many photopolymers, issues such as delamination and warping can occur when printing at the open surface of the photopolymer. Significant time and/or hardware can be required to avoid these problems. It is therefore advantageous to print/cure at and/or along an interface of a fluid, which is greater in density than that of air. Systems, apparatus, and methods described herein can provide a light source placed below the vessel containing a relatively higher density fluid. In some embodiments, the light source can be placed on the underside of the photopolymer. Alternatively, to enable curing of the photopolymer at an interface of an optically clear fluid (e.g., a liquid) having density greater than that of air but less than the photopolymer such that the photopolymer rests below the optically clear fluid, the light source can be provided at other locations (e.g., above the vessel). The process of curing associated with such systems, apparatus, and methods is referred to herein as Solid-Liquid Interface Curing (SLIC).

3D manufacturing or additive manufacturing devices and methods may use computer controlled light engines to dynamically direct light at certain portions of a photopolymer. A vessel containing a photopolymer can form a part of the 3D manufacturing device. Objects manufactured using a 3D manufacturing device are typically cured within a vessel against an optically clear window to avoid the aforementioned issues with printing at an open surface of the photopolymer. Once cured, a force exists that can hold the cured layer against the window. This force can be, for example, primarily comprised of a vacuum force (low pressure zone) created by the photopolymer shrinking and van der Waals forces to lesser extent. This force is overcome in order to move (e.g., raise) the print bed into position for curing the next layer of photopolymer. The mechanism and/or method used to overcome this force can be referred to as a release mechanism herein. The objective of the release mechanism is to be gentle and fast so as to not damage the cured layer but optimise the print speed. Devices and methods described herein do not require an optically clear window to cure against and thus have no requirement for a release mechanism, while also preventing the problems associated with printing at an open surface of a photopolymer.

The additive manufacturing and printing processes described herein provide several advantages over other 3D printing methods, including, for example, higher manufacturing speeds and lower cost, because such systems and methods do not require a release mechanism and/or do not require the printing process to stop to perform the release mechanism.

A device according to the present disclosure can include a 3D printer and a vessel that contains a volume of a photopolymer and a volume of optically clear and UV transmissive interface fluid. In addition to these components, the device can also include one or more of: a build plate that can be held parallel to an opening of the vessel (e.g., a print bed or surface upon which an object can be printed) and a build arm attached to a build plate (e.g., print bed) which attaches to the printer once installed.

In an embodiment, the vessel can contain a photopolymer that can float upon (e.g., be disposed above) a higher density optically clear fluid. An example of a higher density optically clear fluid is saline. The fluid can act as an interface between a light source (e.g., being used to cure the photopolymer) and the cured photopolymer. The higher density optically clear fluid being between the light source and the photopolymer can reduce a low pressure force created due to the photopolymer shrinking when being cured as well as any other forces which would otherwise act to keep the cured photopolymer against a solid substrate. During operation, the electromagnetic radiation from the light source passes through the bottom side of the vessel, which is optically clear and UV transmissive in the desired wavelength. An example of a suitable material for the vessel bottom is acrylic. The light then passes through the higher density fluid and subsequently cures a photopolymer, in a desired pattern, that is one “layer height” thick at a start of the printing process. The photopolymer can be one layer height thick because a print bed can be placed in a position that is one layer height away from the higher density optically clear fluid at the start of the printing process, such that the cured photopolymer (e.g., resin) adheres to the print bed surface, and can be moved, e.g., in a controlled and automated fashion, enabling curing (e.g., continuous curing) without requiring a separation or release mechanism step (e.g., to release or separate cured photopolymer from a print head) to be performed before emitting light from the light source to cure the next layer of photopolymer. Stated differently, systems, apparatus, and methods disclosed herein can provide a device that can cause photo initiators in a photopolymer composition to become photoinitiated and harden the polymer in a controlled way, continuously, e.g., without stopping to perform a release mechanism step.

The vessel design can be such that it can be mounted inside of a 3D printer, and the light source may be placed above or below the vessel, and the print bed can enter the vessel through a top side via an opening. Movement of the print bed is performed in a controlled and automated fashion along a single vertical axis (e.g., z axis) of motion. The vessel utilised with a digital light source (e.g., such as a Digital Light Projection (“DLP”) system) and print bed contained within a 3D printer device, which are each described herein, is capable of curing photopolymer continuously throughout the printing process by controlling the specific point (e.g., portion) in the photopolymer that is exposed to electromagnetic radiation without having to stop to perform “separation” (e.g., release or separation of a cured layer from a printer component).

In some embodiments, the devices described herein can be used with methods such as SLIC, as described herein. The devices, described in relation to SLIC, have particular applications, for example, in the Industrial production of parts or objects as well as rapid prototyping, e.g., in automotive manufacturing, product design or consumer applications, where speed and cost are important. The disclosed devices also have applicability in Science, Technology, Engineering, the Arts and Mathematics (STEAM) applications and other educational applications, including educational programs.

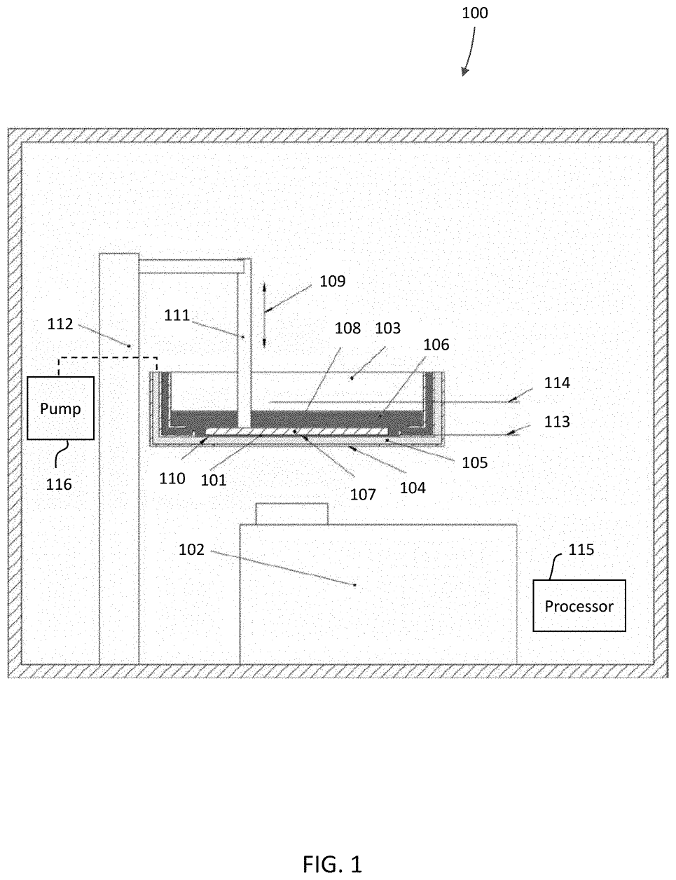

With reference to FIG. 1, a system 100 is shown for devices and methods for implementing an additive manufacturing process. The system 100 includes a pattern 101 being cured, a light source 102 (e.g., a DLP system), and a vessel 103. The vessel 103 has a bottom side 104, which is made of an optically clear and UV transmissive rigid material such as acrylic. Disposed within the vessel 103 adjacent the bottom side 104 is an “interface fluid” 105, which is optically clear and UV transmissive and which may be denser than a photopolymer 106 that is being cured by the light source 102 during the printing process. The 3D printing system 100 contains the light source 102 for curing a photopolymer 106 during the printing process. During printing, the object being printed, i.e., cured photopolymer, can adhere to a bottom surface 107 of a build plate 108 with greater force than to any other surface as the photopolymer is otherwise in contact with a fluid and/or liquid such as saline. The lack of a solid surface other than the bottom surface 107 of the build plate 108 to adhere to reduces the risk of or prevents vacuum and Van der Waals forces from creating significant action on the cured polymer while raising the print bed along a vertical direction/axis 109 (e.g., z-axis) directly away from an interface plane 110 between the photopolymer and the optically clear fluid. The system 100 further includes a build arm 111, which can be used to move the build plate 108 away from the interface plane 110 during a printing process. The system 100 also includes a linear drive mechanism 112, used to move the build plate 108 during printing. In an embodiment, the linear drive mechanism 112 may, during operation, may move the build plate 108 between a first/start position 113 and a second/end position 114. In the illustrated embodiment, the build plate 108 is arranged parallel to the interface plane 110 during the printing process, e.g., on a level plane relative to the earth.

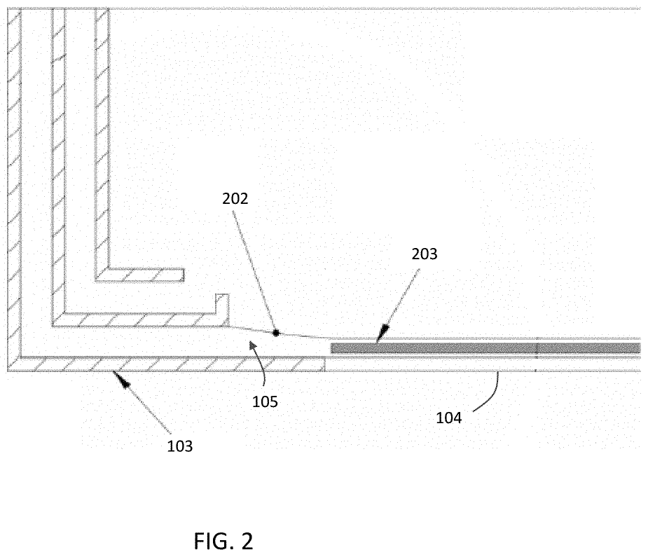

Referring now to FIG. 2, when the interface fluid 105 is contained within the vessel 103 and allowed to rest to a natural settling position, the interface fluid 105 (e.g., a liquid saline) can exhibit a meniscus 202. The vessel 103 is configured such that the exposure of photopolymer 106 takes place within an area 203 to avoid a greater level of image distortion experienced at the edges of the vessel 103, e.g., at the edges of the meniscus 202. In some embodiments, the image or pattern 101 to be exposed in photopolymer 106 may be pre-distorted such that the pattern 101 that is cured, once the light has passed through the various materials and/or interfaces on its path to the photopolymer 106, is the pattern/shape desired for the object.

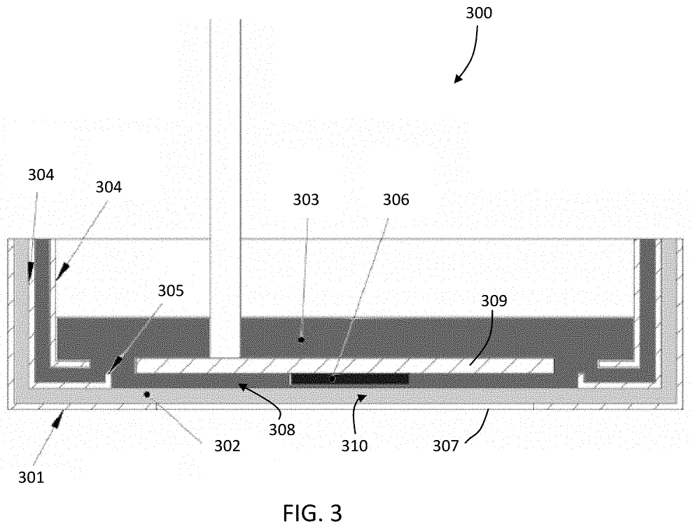

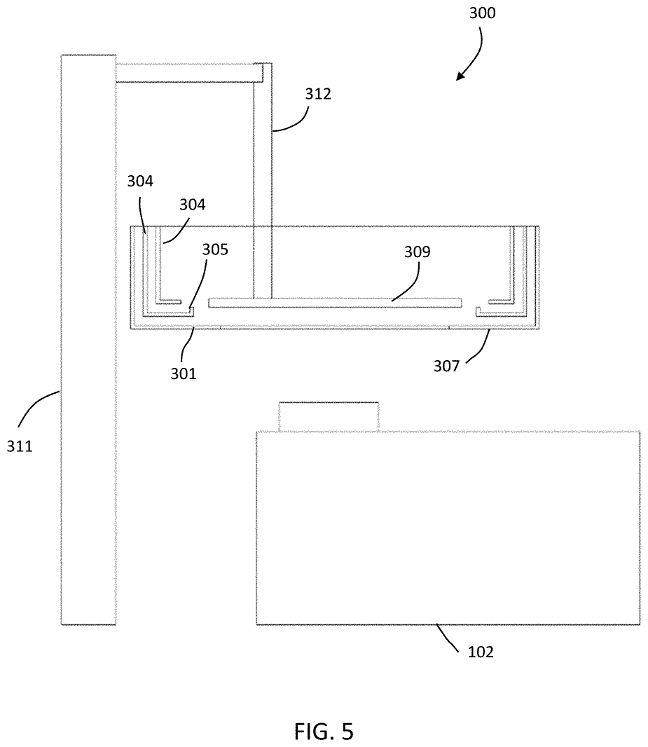

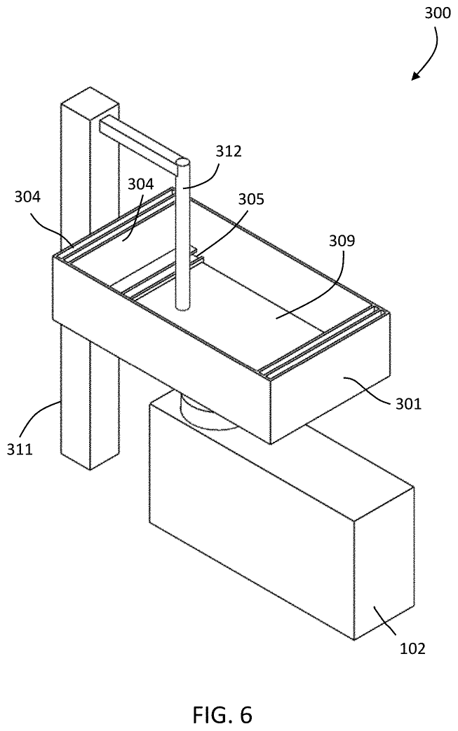

Referring now to FIG. 3 an embodiment of a system 300 is shown having a vessel 301, containing an interface material 302 (e.g., a liquid) having a density greater than that of the photopolymer 303. The interface material 302 has a composition such that the interface material 302 is optically clear and transmissive to a desired wavelength of electromagnetic radiation emitted by light source 102 to enable electromagnetic radiation to pass through the interface material 302 such that it cures the photopolymer 303 in a desired pattern. A light source 102 used with the vessel 301 may be turned on and off via electronic control. The vessel 301 may have interior structural features 304 (e.g. conduits or passages), which aid in obtaining a non-homogenous interface, i.e., aids in installing (e.g., flowing or placing) the photopolymer 303 and/or interface material 302 in the vessel 301. In some embodiments, this is desirable as the photopolymer 303 may be placed upon the interface fluid in a low-force/gentle manner. The structural features 304 can confine the print area such that the print area is away from a high point of a meniscus 202 exhibited between the interface fluid 302 and the photopolymer 303. In this example depicted in FIGS. 3-6, a feature 305 (e.g. a wall) is provided at the end of the structural feature for directing the flow of photopolymer 303 flow upwards (e.g. away from the bottom side 307 of vessel 301) at a point of entry into a central portion 308 of the vessel 301 where the photopolymer 303 comes into contact with the interface fluid 302. When the photopolymer 303 is cured, the interface between the cured photopolymer 303 and the light source 102, i.e., the interface material 302, can be a liquid (e.g., saline). Accordingly, there is little or no oxygen present/available at the interface to inhibit the curing process of the photopolymer 303 and as such, the photopolymer 303 (e.g., resin) can cure up to the interface plane. Thus, post curing of a layer of the photopolymer, “separation” occurs between the cured photopolymer 306, now a solid, and the interface material 2 implemented as a liquid. The cured photopolymer 306 can be more rigid than the interface material 302 and, therefore, can move away (e.g., separate) from the interface material 302 with reduced risk of damage. As the build plate 309 moves away from the interface material 302 (e.g., in an upwards direction away from the bottom 307 of the vessel 301 via build arm 311 and linear drive mechanism 312), any interface material 302 (e.g., fluid) residing on the surface of the cured photopolymer 306 can, due the difference in density between the interface material 302 and the photopolymer 303, flow to a lower portion 310 of the vessel 301 (e.g., where the rest of the interface material 2 resides) with uncured photopolymer 303 flowing to fill the planar void (e.g., space) created by the movement of the build plate 309 upwards. This process of curing is referred to as Solid-Liquid Interface Curing (SLIC), and vessels 103, 301 usable in the process can be referred to as a SLIC—Vessel herein.

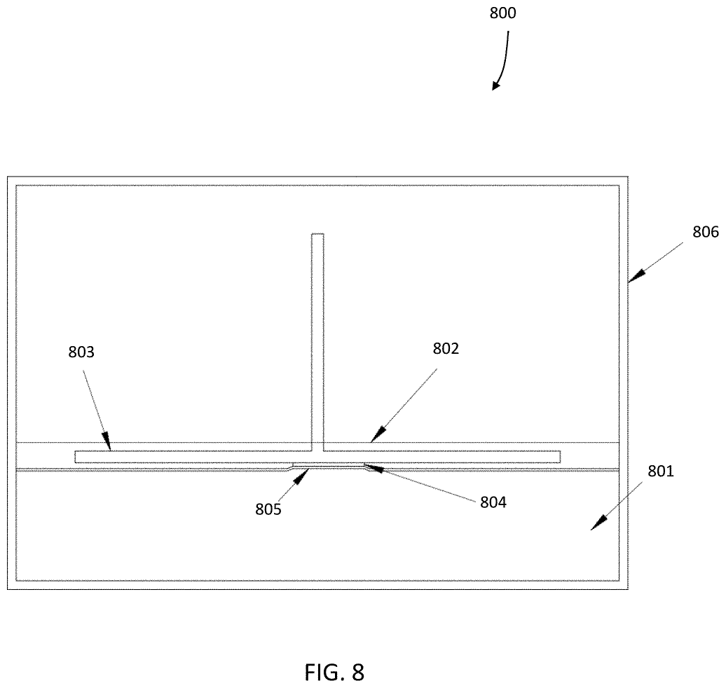

Referring now to FIG. 8, an embodiment of a system 800 is shown, utilising the process described herein, at a time during the printing process which is useful for describing the difference in operation when compared to methods common in the art. The relatively higher density and optically clear interface fluid 801 is residing at the bottom of the vessel 806. The photopolymer 802 is resting upon the higher density interface fluid 801. A printed object 804 is being formed upon the build plate 803. An area 805 is where curing of the photopolymer 802 is taking place due to exposure to a electromagnetic radiation from a light source 102, where an upward curve can be seen. It should be appreciated that the illustrated upward curve is larger than in practicality but is shown as depicted for clarity.

With reference to the embodiment of FIG. 8, one difference in operation of the process described herein can be readily described at a point in time just after a layer curing. As depicted in FIG. 8 by an upward curvature of the printed object 804, the photopolymer shrinks slightly when cured. If the relatively higher density fluid 801 residing at the bottom of the vessel 806 were a solid or flexible material such as PDMS, the shrinkage would result in an area of low pressure forming between the PDMS and the printed object 804 residing on the build plate 803. This arrangement places a force on the printed object 804 as the build plate 803 moves/lifts away, and commonly in the prior art systems, the build plate 803 must lift multiple times the layer height being printed before returning to a position one layer height above its previous curing position. In the absence of a rigid material, in this instance a liquid, the non-rigid fluid is drawn upward as the component shrinks due to surface tension at the interface of the solid part 804 and liquid photopolymer 802. In this embodiment, a low-pressure region cannot form beneath the printed object 804 as the distance between the photopolymer 802 and the relatively higher density interface fluid 801 remains constant.

### Solid-Liquid Interface Curing (SLIC)

Referring back to FIG. 1, 3D printing device or system 100 will be further described according to embodiments herein. Making reference to FIG. 1, the SLIC process uses a vessel (e.g., SLIC—Vessel). The photopolymer 106 is contained within the vessel 103 as well as the interface fluid 105. The printed object is built up by moving the build plate 108 away from the interface fluid 105 continuously in a controlled fashion as the light source 102 continuously and dynamically shows a pattern 101 for the current layer height. The process (SLIC) and apparatus (SLIC—Vessel) allow for continuous “separation” of the cured photopolymer from the interface fluid, thereby enabling continuous movement of the build plate 108 and curing by the light source 102 where otherwise the interface of the solid print and the solid vessel base would allow for an area of low pressure to form. The light source 102 can be contained within the system 100 and the light from the light source 102 can be directed at the vessel 103 such that the light from the light source 102 strikes perpendicular to the vessel bottom side 104. The first slice/layer can represent the bottom of the object as viewed from above (e.g from the top side of the system 100. The second slice/layer can be the geometry of the object one layer-height higher and so on until the last layer, representing the top of the object, is printed. Printing continuously enables thinner slices to be utilised without increasing the overall print duration. It should be appreciated that thinner slices/layers can result in a technical effect, for example, greater quality of the produced/printed part. The process can use a build plate 108 which can move in a z-direction (e.g., along the axis 109) within the vessel 103 containing photopolymer 106.

To manufacture any given object (e.g., 3D model), the build plate 108 is lowered into the vessel 103 such that a bottom surface of the build plate is 1-layer height above the top surface of the interface fluid 105. In some embodiments, the volume of the interface fluid can be adjusted. Such volume adjustments can be accomplished via an on-board (e.g., contained within the system 100) processor 115 that can control a fluid pump 116, e.g., in an automated fashion. The build plate 108 can be attached to a build arm 111, which in turn can be attached to other portions of the system 100.

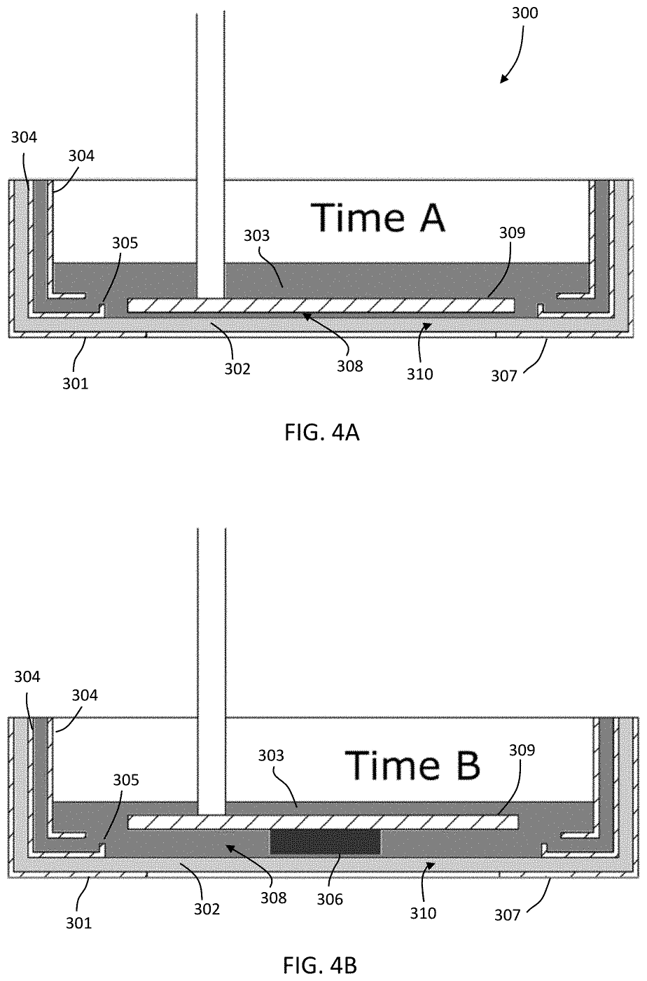

When in its initial starting position, e.g., as illustrated in FIG. 1, position 113, which corresponds to the position shown in FIG. 4A, Time A, for the system 300. with the build plate 108, 309 in the position 113, the printing/fabrication process can begin. The light source 102 can be turned on, such that its light passes through the vessel 103, 301 and interface material 105, 302 and subsequently cures the photopolymer 106, 303. This cures a planar pattern 101 of photopolymer 106, 303 of a predeterminable cross section, thickness, and/or volume. Based on the pattern 101 formed by the light, which provides the cured photopolymer, a layer of the object has been cured (e.g., printed). Next, the build plate 108, 309 is moved away from the interface plane 110 (e.g., moved in a direction that increases a distance between the build plate 108, 309 and the interface material 105, 302) a distance of 1-layer height, e.g., via motorised linear drive mechanism 112. The light source 102 can then display a pattern 101 for the second layer of the object being fabricated. The process then repeats with the build plate 108, 309 moving one-layer height further away on successive layers until the object is built up (Time B, FIG. 4B). It can be understood by those skilled in the art that “continuous,” as used in the context described herein, refers to the lack of a need to stop for a separation step in the printing process (e.g., separating the cured photopolymer from the bottom of the vessel), but can include other delays, e.g., due to the digital nature of the equipment. For example, although a light source 102 may need to switch off between changing images for different layers of the object, “continuous” can refer to a succession of images, e.g., like a video, which is perceived as continuous, rather than showing an image, perceiving a period of time (e.g., a number of seconds), and then displaying another differing image. For example, in numerical and practical terms, “continuous” can be described as showing at 24 frames (images/patterns) per second as opposed to a frame per cycle of the printing process including time for separation between showing each frame. Any suitable framerate may be used. The difference in time to complete a cycle, for any given layer height, can be described as:

Continuous cycle time=Cure Time+Time to move build plate 108 to a position 1−layer height from its previous position

As opposed to:

Non-continuous cycle time=Cure Time+Time to lift some distance away(Separation time)+Time to move print bed to a position 1−layer height from its previous position

Eliminating the additional separation time has time saving advantages, e.g., when there may be thousands or tens of thousands of layers in a single print, and the separation times being tens of seconds or more depending on the technique and process used.

### Solid-Liquid Interface Additive Manufacturing Device

Devices described herein, such as example systems and devices set forth in FIGS. 1-6 can include components required for a printing process, including, for example, an additive manufacturing device main body (e.g., a 3D printer) comprising a vessel (e.g., SLIC—Vessel) described herein alongside a number of subcomponents.

### 3D Printer

As shown in FIG. 1, the system 100 can include a build arm 111 attached to a linear guide axis and motion components 112, build plate 108 attached to a build arm 111, a SLIC—Vessel 103 containing an interface fluid 105 and photopolymer 106. The system 100 can also include a light source 102 capable of emitting the desired wavelength of electromagnetic radiation for photopolymer curing (e.g., crosslinking), in the desired areas of the build area dynamically. The light source 102 can be turned on and off via electronic control elements (e.g., a processor) during the printing/fabrication process.

The system 100 is capable of moving the build plate 108 along an axis (e.g., along a direction indicated by arrow/axis 109). The system 100 may also contain subcomponents that may or may not be necessary for the operation of the end SLIC—Vessel 103, such as, for example, fluid pumping apparatus 116 and associated electronics 115. It should be noted that the photopolymer 106 has a natural resting thickness. The layer of photopolymer supported by the relatively higher density interface fluid may be thicker than the natural resting thickness. This resting thickness is a result of the materials characteristics such as viscosity which can be affected by variables such as temperature. Therefore, a desired condition of variables exists for a particular photopolymer 106 and it can be understood that these variables are controllable through additional printer components such as heating elements (not shown).

Certain technical advantages associated with the continuous curing of a photopolymer during a printing process, to which the processes and system described herein refer (e.g., the assembly and/or methods of the present embodiments, including SLIC and SLIC—Vessel), include but are not limited to: the reduction of forces between the printed object and the interface material allowing for gentler separation (e.g., less force to be overcome for separation) and thus less risk of damage to the cured photopolymer or printer; the continuous separation of cured photopolymer does not impede or stop the curing/printing process. For example, the light source does not have to turn off in order to complete the separation of cured photopolymer allowing for faster 3D printing; issues associated with printing at the open surface are mitigated by printing in a submerged fashion; and the high density fluid may act like a lens, having a higher refractive index than that of air (by design), allowing relatively finer details to be resolved by the image source.

### SLIC Device(s) Use and Operation

In operation, a user can plug in (e.g., connect a power source to) a manufacturing device (e.g., the 3D printing system shown in FIGS. 1-6, or any other embodiments described herein). The user then loads a 3D object file (e.g., of a particular print) onto the device, e.g., using software installed on a processor of the device.

The user can select various settings relative to the particular print and photopolymer in use. The user can start the print via an interaction of software and hardware (e.g., via a user interface, such as visual and/or audio user interface) which can be, for example, described in an operating manual. Once the print has begun, the printer dynamically moves the print bed as needed in a pre-determined fashion. Once a “layer” of the path (e.g., a layer of the print) has been completed, the build plate is moved upwards (e.g., away from the interface material) at a rate defined previously. While the build plate is moving upward, the light source is emitting the desired pattern for the build plate's current height (e.g., current layer) such that the light cures the photopolymer in the desired pattern. The rate of motion of the build plate is pre-determined such that the light source may have sufficient time to cure a layer pattern. This process continues until the desired object is built up.

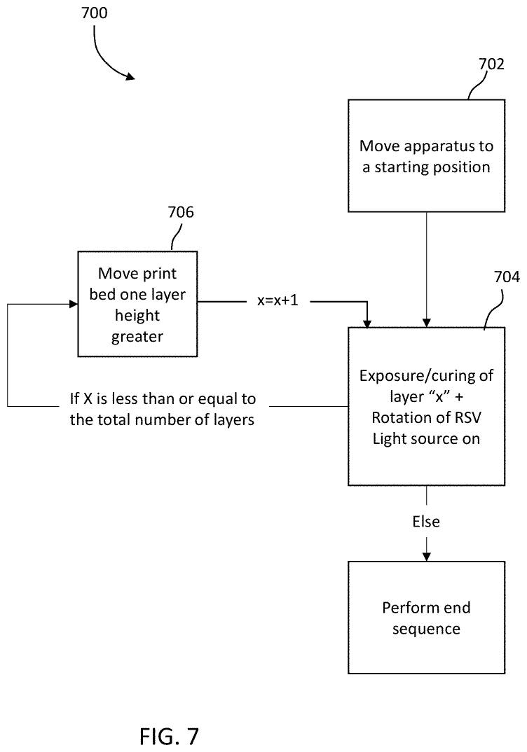

FIG. 7 depicts an example operational flow of the operation of a manufacturing device(s), according to embodiments described herein. FIG. 7 illustrates an embodiment of a method 700 of operating a manufacturing device, such as device 100 for example, according to embodiments described herein. The method 700 starts in block 702 where the device is moved to a starting position. This may include moving the build-plate 108 to position 113 for example. The method 700 then proceeds to block 704 where the light source 102 is activated to cure the photopolymer 106. When the current layer is not the last layer (e.g. layer “X” is less than the total number of layers), the method 700 loops to block 706 where the print-bed/build-plate or the end effector is moved a distance equal to one layer height or greater.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various methods and/or processes outlined herein can be coded as software that is executable on one or more processors that employ any one of a variety of operating systems or platforms. Additionally, such software can be written using any of a number of suitable programming languages and/or programming or scripting tools, and also can be compiled as executable machine language code or intermediate code that is executed on a framework or virtual machine.

In this respect, various disclosed concepts can be embodied as a non-transitory computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers/compute device and/or other processors to implement various aspects of the present disclosure as discussed above.

The terms “program” or “software” are used herein in a general sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure can be distributed in a modular fashion amongst a number of different compute devices/processors to implement various aspects of the disclosure.

Processor-executable instructions can be in many forms, such as program modules, executed by one or more compute devices, and can include routines, programs, objects, components, data structures, etc. that perform particular tasks or implement particular data types, and the functionality can be combined and/or distributed as appropriate for various embodiments.

Data structures can be stored in processor-readable media in a number of suitable forms. For simplicity of illustration, data structures may be shown to have fields that are related through location in the data structure. Such relationships can likewise be achieved by assigning storage for the fields with locations in a processor-readable medium that conveys relationship(s) between the fields. However, any suitable mechanism/tool can be used to establish a relationship between information in fields of a data structure, including through the use of pointers, tags or other mechanisms/tools that establish relationship between data elements.

Also, various concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A method comprising:
flowing an interface fluid into a vessel, the interface fluid having a first density;
flowing a photopolymer into the vessel, the photopolymer having a second density, the second density being less than the first density;
disposing a build plate within the photopolymer, the build plate being positioned a predetermined layer thickness from an interface of the photopolymer and interface fluid;
irradiating at least a portion of the photopolymer with a light source to define a first layer of an object being fabricated, the portion of the polymer being disposed between the interface fluid and the build plate; and
moving the build plate in a direction away from the interface fluid a predetermined second distance.

2. The method of claim 1, further comprising repeating the steps to define a second layer of the object being fabricated.

3. The method of claim 1, further comprising directing the flow of photopolymer upwards as the photopolymer enters the vessel and prior to contact with the interface fluid.

4. The method of claim 1, wherein the interface fluid is saline.

5. The method of claim 1, further comprising forming a meniscus with the interface fluid near the edge of the vessel, wherein the portion of the photopolymer is spaced apart from the meniscus.

6. The method of claim 1, further comprising flowing photopolymer into a space between the first layer and the interface fluid in response to moving the build plate.

7. The method of claim 1, further comprising continuously moving the build plate while the light source continuously and dynamically irradiates the photopolymer.

8. The method of claim 7, further comprising continuously separating the cured photopolymer from the interface fluid as the build plate is moved.

9. A system for forming an object through additive manufacturing, the system comprising:
a vessel having a bottom side;
an interface fluid disposed within the vessel;
a photopolymer disposed within the vessel and in contact with the interface fluid;
a build plate disposed within the photopolymer and spaced apart from the interface fluid, the build plate being movable from a first position to a second position; and
a light source positioned to direct electromagnetic radiation into the build plate.

10. The system of claim 9, wherein the interface fluid is saline.

11. The system of claim 9, wherein the vessel includes at least one first structural feature configured to flow interface fluid into the vessel.

12. The system of claim 11, wherein the vessel includes at least one second structural feature configured to flow photopolymer into the vessel.

13. The system of claim 11, wherein the second structural feature includes a lip configured to direct photopolymer upwards as the photopolymer enters the interior of the vessel.

14. The system of claim 9, further comprising one or more processors configured to continuously move the build plate as the light source continuously and dynamically irradiates the photopolymer in a predetermined pattern.

15. The system of claim 9, wherein the vessel includes an optically clear window between the interface fluid and the light source.

16. The system of claim 9, further comprising a linear drive mechanism operably coupled to the build plate, the linear drive mechanism being configured to move the build plate between the first position and the second position.

17. The system of claim 16, further comprising a build arm coupled between the linear drive mechanism and the build plate.

18. The system of claim 9, further comprising a pump operably coupled to flow interface fluid into the vessel.
